(19) United States
(12) Patent Application Publication
(10) Pub. No.: US 2021/0049927 A1
(43) Pub. Date: Feb. 18, 2021

(54) SYSTEM, METHOD AND COMPUTER PROGRAM PRODUCT FOR DETERMINING A READING ERROR DISTANCE METRIC

(71) Applicant: Vanderbilt University, Nashville, TN (US)

(72) Inventors: Neena Marie Saha, Nashville, TN (US); Sage Pickren, Nashville, TN (US); Laurie E. Cutting, Nashville, TN (US)

(21) Appl. No.: 16/992,777

(22) Filed: Aug. 13, 2020

Related U.S. Application Data
(60) Provisional application No. 62/886,066, filed on Aug. 13, 2019.

(51) Int. Cl. G09B 17/00; G10L 15/22; G10L 15/187; G10L 15/10; G06F 3/16

(52) U.S. Cl. CPC G09B 17/003; G10L 15/22; G06F 3/167; G10L 15/10; G10L 15/187

(57) ABSTRACT

Described and disclosed herein are embodiments of systems, methods and computer program products for determining a grapho-phonetic strategy (GPS) metric that informs how far a particular word-reading error is from the target word and explains where the breakdown occurred. For example, if a person saw the word “cat” and mis-read it as “cap” the GPS metric would be low, suggesting that this particular error was not that far from the target word. However, if a person mis-read “cat” as “climb” the GPS metric would be higher because they only read the initial sound correctly. The GPS metric can be calculated for each mispronounced word in a passage and totaled to yield a passage score. The GPS metric can also be used to develop a tailored improvement process for the person.

### CROSS-REFERENCE TO RELATED APPLICATION

This application claims priority to and benefit of U.S. provisional patent application Ser. No. 62/886,066 filed Aug. 13, 2019, which is fully incorporated by reference and made a part hereof.

### BACKGROUND

All children make errors as they learn to read, yet there is no automated, sub-lexical way to distinguish how close the approximation was to the target word and what the approximation can tell us about reading achievement (screening), reading growth (progress monitoring), or how to modify instruction, pick appropriate texts. For example, when children first attempt to read words, before they have received instruction, they will often use a book's pictures or illustrations to guess the word. However, after receiving instruction, children will know to look at words, not pictures, when attempting to read a word. This latter approach represents a more mature or developed word recognition strategy than guessing based on pictures. As children continue to receive instruction, and apply what they have learned, they will attempt to read words by examining the letters sequentially, and eventually will be able to automatically recognize letter that combine to form graphemes which represent single sounds in the English language. The final stage of reading fluency is denoted by quick, accurate, effortless word recognition. The path to getting to this stage requires a constant feedback and redirection of errors so that approximations of words turn into accurate representations. This fine-tuning is a process that directly involves practitioners such as reading teachers, reading specialists, reading tutors, and homeschooling parents. However, currently, there is no guidance provided to these practitioners on how to fine-tune the process of children's word reading.

In fact, there is not even a non-automated way of measuring the sub-lexical accuracy of a child's word reading approximation. Currently, even in the latest reading research studies, entire words are marked incorrect even if only one sound was mis-read (for example, “cap” for “cat”). However, the child who consistently makes errors similar to mis-reading “cat” as “climb” would most likely need more (or a different type of instruction) than the child who mis-reads “cat” as “cap.” This is most likely due to the fact that English is opaque, and knowledge of all the letter-sound (grapheme-phoneme) relationships in English is difficult if not impossible. Research has even shown that reading teachers do not have adequate knowledge of the letter-sound relationships in the English language (see, for example, Moats, L. (2009). Still wanted: Teachers with knowledge of language. Journal of Learning Disabilities, 42(5), 387-391, which is incorporated by reference). However, if there was technology that could quantify word recognition strategy from guessing, on the one end to effortless, errorless word recognition, on the other, that would alleviate the burden of expert knowledge, save time, and reduce human error in scoring, thus increasing reliability and accuracy of the results. It is important to note that even more advanced readers, who adopt a more ‘mature’ grapho-phonetic strategy (GPS), might still make minor sub-lexical errors. For example, a child might use the less common sound of /s/ for the letter ‘c’ than the /k/ sound of the letter ‘c’. While the child certainly made an error, this error would represent a more developed GPS strategy than a child who ascribed a sound to the letter ‘c’ that is impossible in the English language. In this way, subtle, sub-lexical GPS can inform instruction: perhaps that child needs to review the rules for the letter ‘c’ rather than being told to ‘sound out each letter’ (something that they have already mastered). This distinction is important because current speech recognition engines would pick up on the error (/s/ vs /k/) but would not be able to inform strategy use.

Therefore, what are needed are systems, methods and computer program products that overcome challenges in the art of quantifying word recognition strategy and reading error analysis, some of which are described above.

### SUMMARY

Described and disclosed herein are embodiments of systems, methods and computer program products for determining a graphophonetic strategy (GPS) metric that informs where, on the spectrum of word recognition (from guessing to effortless, errorless reading), a child stands. For example, if a person saw the word “cat” and mis-read it as “cap” the GPS measure would be low, suggesting that this particular error was not that far from the target word, and represents a mature, instruction-informed approach to word recognition. However, if a person mis-read “cat” as “climb” the GPS metric would be higher because they only read the initial sound correctly. The GPS metric can be calculated for each mispronounced word in a passage and totaled to yield a passage score. The GPS metric can also be used to develop a tailored improvement process for the person who is learning how to read.

It should be understood that the above-described subject matter may also be implemented as a computer-controlled apparatus, a computing system, or an article of manufacture, such as a computer program product stored on a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a flowchart for an embodiment of a process for determining a Grapho-Phonetic Strategy (GPS) metric;

FIG. 1B is a flowchart that illustrates a more detailed overview of a process for determining a GPS metric;

FIG. 2A is a flowchart illustrating one exemplary method of calculating a GPS score for word-error pairs;

FIG. 2B is a flowchart illustrating another exemplary method of calculating a GPS score for word-error pairs;

FIG. 2C is a flowchart illustrating yet another exemplary method of calculating a GPS score for word-error pairs;

FIG. 3 is an example of generated and displayed results of a calculated GPS panel;

FIG. 4 illustrates a flowchart for an exemplary method of determining a decodability index (DSyM) for one or more words;

FIG. 5 is an example illustration of determining the decodability index for two separate words, “airplane” and “jet”;

FIG. 6 illustrates and describes a method of calculating the GPS metric for a word-error pair when the error word is a real word using machine-learning clustering algorithms performed by the computing device;

FIG. 7 illustrates and describes a method of calculating the GPS metric for a word-error pair when the error word is a real word using machine-learning prediction algorithms;

FIG. 8 illustrates yet another exemplary method of calculating the GPS metric for a word-error pair when the error word is a real word using item response theory;

FIG. 9 illustrates and describes calculating the GPS metric for a word-error pair when the error word is a real word using syntax and meaning methods;

FIG. 10 illustrates and describes an exemplary method of calculating the GPS metric for a word-error pair when the error word is a made-up word using an error encyclopedia;

FIG. 11 illustrates and describes an exemplary method of calculating the GPS metric for a word-error pair when the error word is a made-up word by determining a distance of the error word from a native or dominant language word;

FIG. 12 is a flowchart that illustrates an exemplary process of evaluating reading instruction using a GPS metric; and

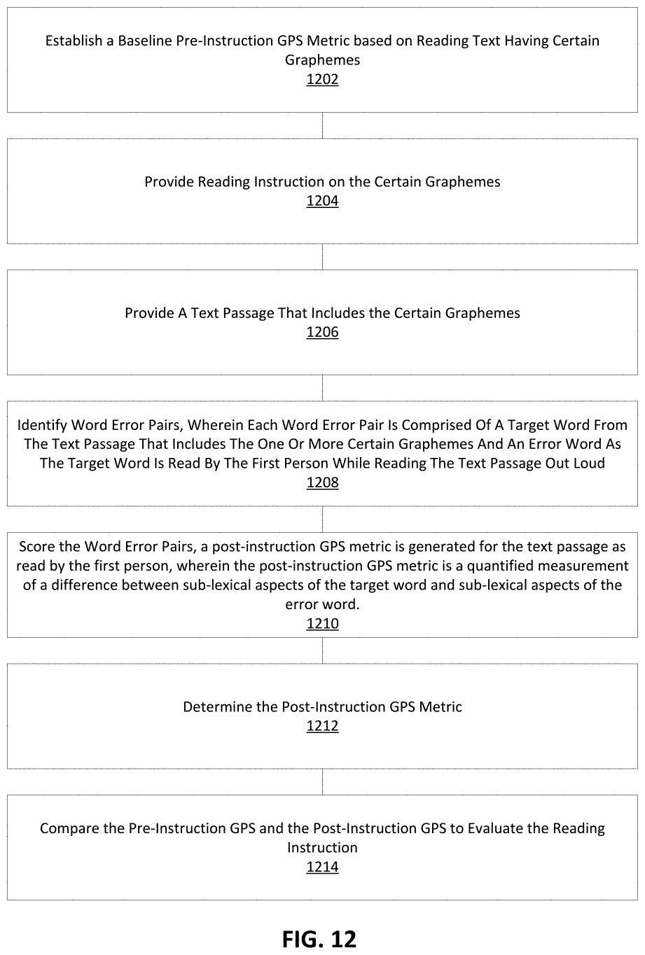

FIG. 13 is a block diagram of an example computing device upon which embodiments of the invention may be implemented.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Furthermore, as used herein, the terms “word” or “words” includes a complete word, only a portion of a word, or a word segment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

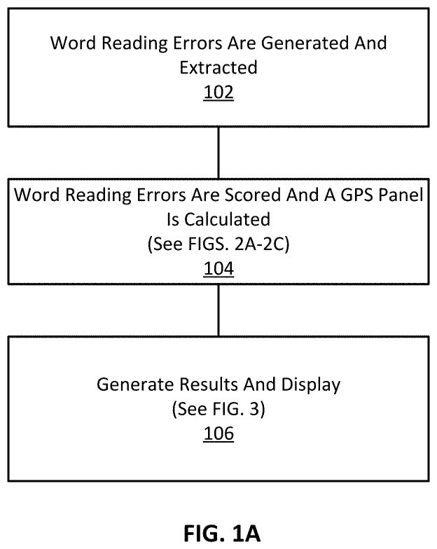

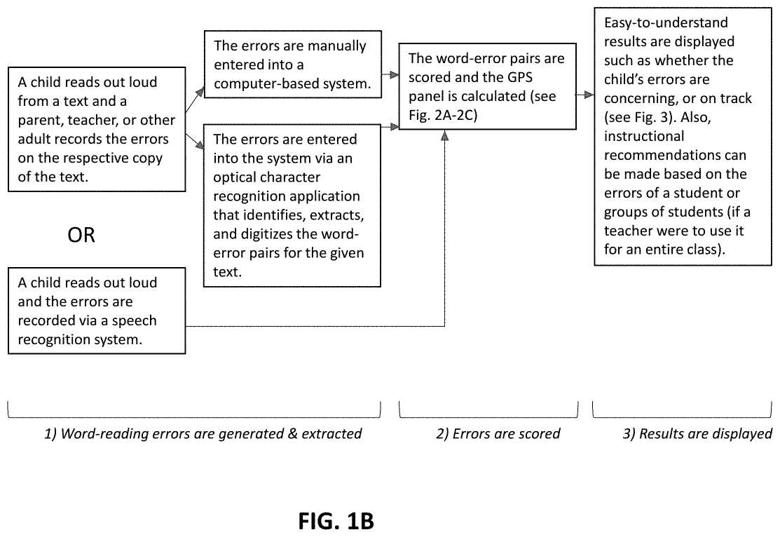

FIG. 1A is a flowchart for an embodiment of a process for determining a Grapho-phonetic Strategy (GPS) metric. At step 102, word reading errors are generated and extracted. For example, a first person (e.g., a child) reads out loud from a text passage and a second person (e.g., a parent, teacher, etc.) records the errors as the words are read from the text passage. In some instances, the text passage is all or part of a R-CBM (reading curriculum based measurement). Notably, this procedure could also be applied to any text or book an individual reads aloud. Generally, as the first person reads out loud, the second person marks the first person's word-reading errors. Specifically, a word may be marked as incorrect by putting a slash through it. If incorrect, the second person may also write down the incorrect word that they heard the first person say. So, if the word was “word” and the first person said “work,” then the second person would put a slash through “word” and write “work” on the paper above it.

The identified errors are entered into a computing system (described herein). In some instances, the errors are manually entered into the computing system. In other instances, the errors may be entered using a peripheral device such as, for example, a scanner that using optical character recognition that identifies, extracts, and digitizes the word-error pairs for the given text passage. Alternatively, the first person may read the text passage out loud into a microphone and the errors are recorded by a computing system that includes speech recognition software. In this embodiment, a second person may not be required.

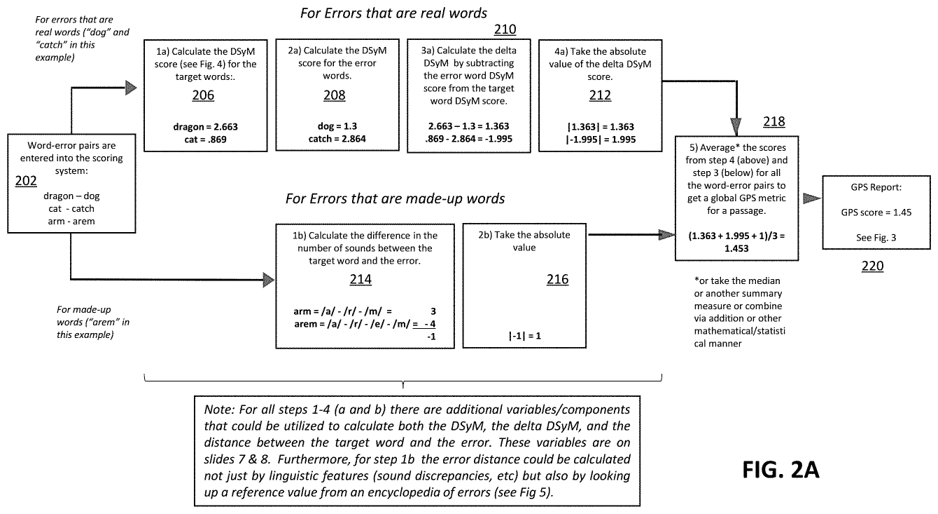

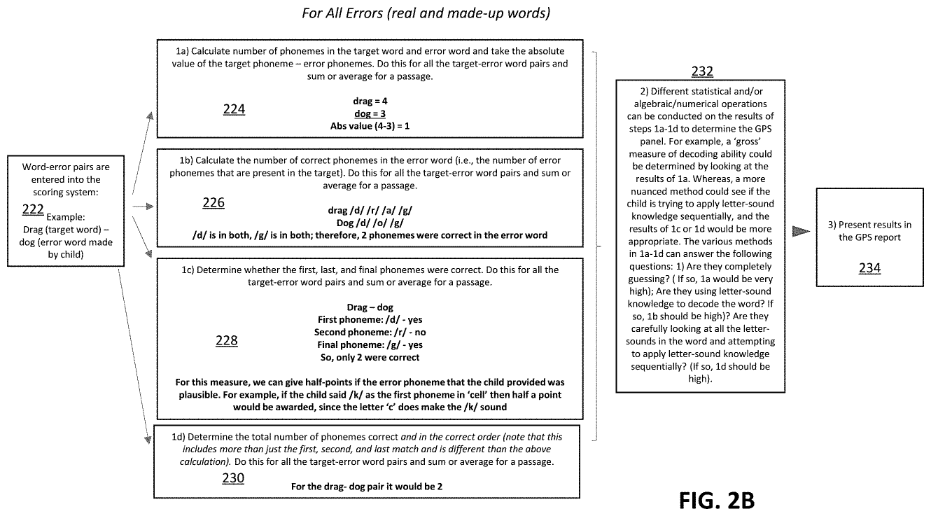

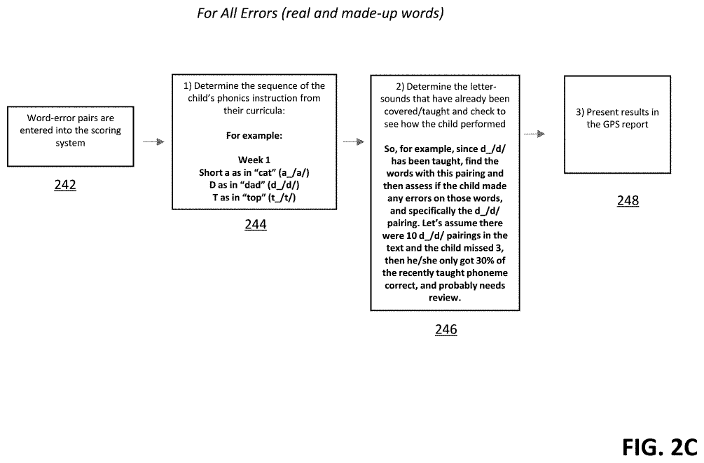

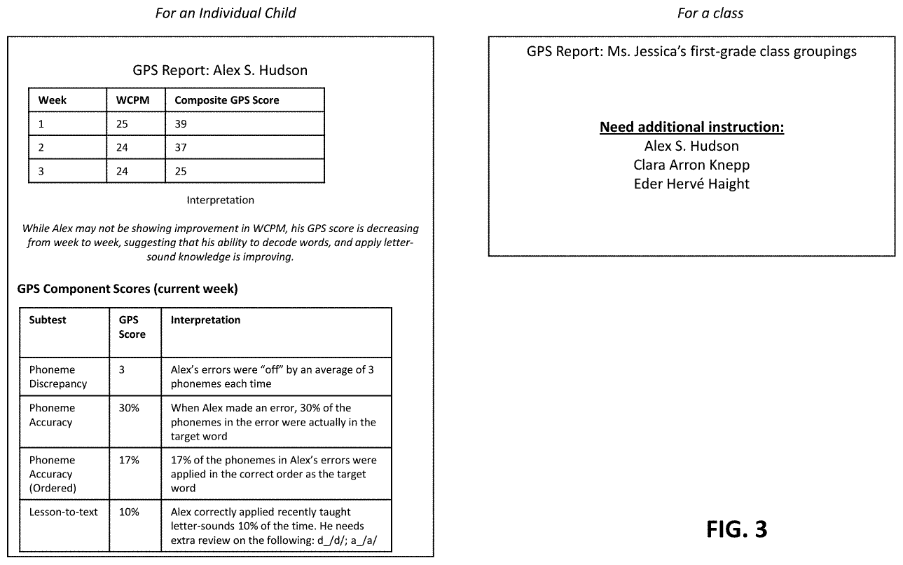

At 104, the errors are scored and a GPS panel is calculated (see FIGS. 2A-2C) by the computing system. Once the GPS panel is calculated, at 106, results are generated and displayed by the computing system (see FIG. 3 for a non-limiting example of results). A more detailed overview flowchart of a process for determining a GPS metric is shown in FIG. 1B.

FIG. 2A is a flowchart illustrating exemplary methods of calculating a GPS score for word-error pairs. At 202, the word-error pairs are entered into the computing system for scoring, as described herein. A word-error pair is comprised of a target word (the word that is in the text passage), and an error word (the word that was said out loud by the first person when reading the target word). At 202, it is also determined whether the error word of each word-error pair is a real word or a made-up word. For example, for a target word “dragon,” the first person may read an error word, “dog” (a real word). In another example, for the target word “cat,” the first person may read the error word “catch” (also a real word). In yet another example, for the target word “arm,” the first person may read the error word, “arem” (a made-up word).

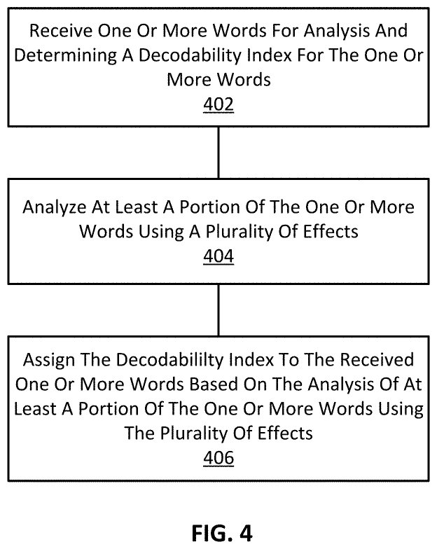

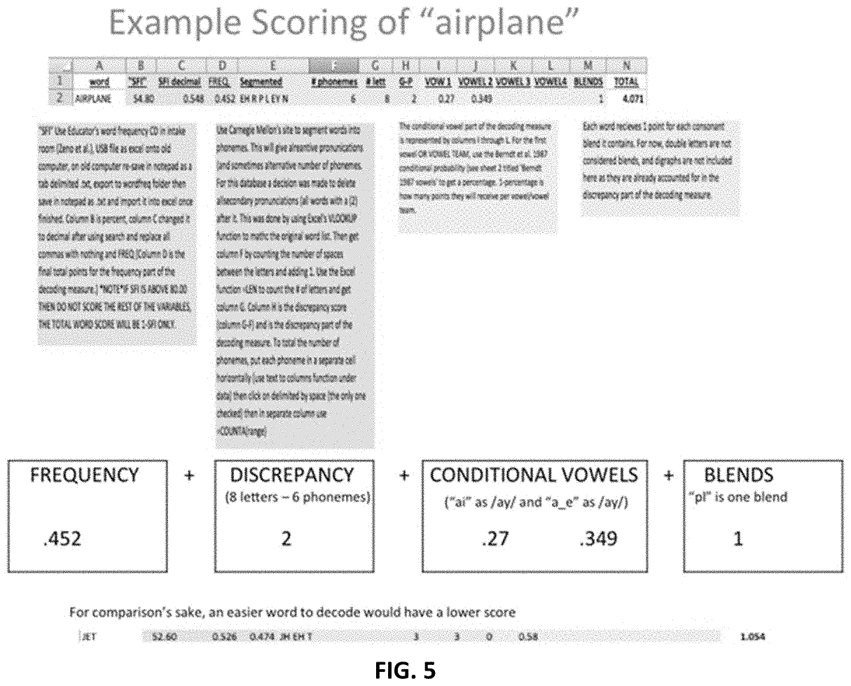

If, at 202, the error word is a real word, then a GPS score is calculated for the target-error word pair when the error word is a real word. This may be done by various processes and/or methods. As one non-limiting example, as shown in FIG. 2A, at 206 a score is calculated by the computing device for the target word. At 208, a score is calculated by the computing device for the error word, and then at 210 the difference (a delta) is calculated by the computing device by subtracting the error word score from the target word score, or vice versa. At 212, an absolute value (multiply any negative value by −1 to obtain a positive value) is taken by the computing device for the value determined at 210. Though various metrics can be used for calculating a score by the computing device for the target word (step 206), and calculating a score by the computing device for the error word (step 208), in some instances a decodability index may be used for scoring both the target word and the error word. Determining a decodability index for a word is described below with reference to FIGS. 4 and 5. As used herein, the word “decode” means a process of translating print into speech by rapidly matching a letter or combination of letters (graphemes) to their sounds (phonemes) and the ability to blend the phonemes with other sounds that surround it. decoding is also the ability to blend that phoneme with other sounds that surround it. For example, a person may know the letter L makes the /l/ sound and be able to read the word “like”, but when that letter is part of a consonant blend (e.g., blob), the person may miss that phoneme and say the word “bob.” Therefore, decoding is not only matching graphemes to their phonemes, but also includes blending them with surrounding phonemes to create/read words. A decodability index; therefore, is a value assigned to a word or group of words that indicates an ability to translate the printed word or group of words into speech by rapidly matching a letter or combination of letters (graphemes) to their sounds (phonemes) and/or blending them with surrounding phonemes to create/read words. The decodability index may be based on a specific person's ability to translate the graphemes of a printed word or group of words to their phonemes, the ability of a group of persons' ability to translate the graphemes of a printed word or group of words to their phonemes, or a representation of an average of all persons' ability to translate the graphemes of a printed word or group of words to their phonemes.

Referring now to FIG. 4, a flowchart is provided for an exemplary method of determining a decodability index for the one or more words. At step 402, one or more words are received for analysis and determining the decodability index for the one or more word. For example, receiving the one or more words may comprise receiving, by a computing system (as described below), the one or more words as an electronic file. The electronic file may be created in various ways. For example, the electronic file may be created by a word processing program. In another aspect, the electronic file may be created by a scanning device (e.g. a scanner) that scans a hard-copy document and creates the electronic file. In yet another aspect, the electronic file may be created by a voice recognition program that converts spoken words into the electronic file.

Returning to FIG. 4, at 404, at least a portion of the received one or more words are analyzed using a plurality of effects. In one aspect, analyzing the received one or more words using the plurality of effects may comprise analyzing all or a portion of the received one or more words using a word frequency effect, a discrepancy effect, and a conditional score such as a conditional vowels effect. In yet another aspect, analyzing the received one or more words using the plurality of effects may comprise analyzing all or a portion of the received one or more words using a word frequency effect, a discrepancy effect, a conditional vowels effect and a consonant blends effect. In addition, analyzing the received one or more words using the plurality of effects may comprise analyzing all or a portion of the received one or more words using one or more of a phonotactic probability effect, an orthographic similarity effect, a neighborhood effect, an age of acquisition effect, an imageability effect, a concreteness effect, a uniqueness point effect, and an onset/rime effect.

When using a word frequency effect to analyze all or a portion of the received one or more words, a SFI (standard frequency index) is determined for each word in a group of words. In one example, every word of a language has an assigned SFI index. For example, SFI indexes for English words can be found at Zeno, S. (1995). The educator's word frequency guide. Brewster, N.J. Touchstone Applied Science Associates, which is incorporated by reference. SFI values are provided in a percent value. In one exemplary embodiment, the percent value is converted to a decimal value and subtracted from 1. For example, in one group of words under analysis the SFI returned for the word, “a” is 83.8 (a percent value). The percent value is multiplied by 0.01 ( 1/100) to convert to a decimal value and get 0.838. The decimal value 0.838 is subtracted from 1 and to obtain 0.162. This is the value for frequency part of the exemplary decoding measure. In one aspect, words with an SFI score of 80 (percent) and greater receive 0 points toward the total since they are so common. This is only one example of determining a word frequency; it is to be appreciated that this disclosure contemplates any other method of calculating a word frequency index within its scope.

When using the discrepancy effect to analyze all or a portion of the received one or more words, the number of phonemes in each word is subtracted from the number of letters in each word. In some instances, if the value after the number of phonemes in a word is subtracted from the number of letters is negative (less than zero), an absolute value is taken such that the value is positive. A computing device can be used to count the number of letters in a word and/or count the number of phonemes. In some instances, the number of phonemes may be found in a look-up table. In some instances, a word may have more than one number of phonemes because of alternative pronunciations. In those instances, rules can be implemented when the computing device is determining the number of phonemes such that the largest number of phonemes is used, the smallest number of phonemes is used, or an average number of phonemes for the word is used.

When using the conditional vowels effect to analyze all or a portion of the received one or more words, the formula uses the Berndt et al. (1987) conditional probability (Berndt, R. S., Reggia, J. A., & Mitchum, C. C. (1987). Empirically derived probabilities for grapheme-to-phoneme correspondences in English. Behavior Research Method, Instruments, & Computers, 19, 1-9, incorporated by reference) to get a percentage. 1 minus the percentage is how many points is calculated per vowel/vowel team. For example, a word has an “A” which is used as a short a sound /a/ has one vowel. The conditional probability of the letter A making the short sound /a/ is 0.54 in Berndt et al. (1987). So, 1−0.54=0.46. 0.46 is then added to the other two parts above.

When using the consonant blends effect to analyze all or a portion of the received one or more words, each word receives 1 point for each consonant blend it contains. Double letters (for example, ‘ll’) are not considered blends, and digraphs (two or more consonant that make one sound such as “ch”) are not included here as they are already accounted for in the discrepancy part of the decoding measure.

Returning to FIG. 4, at 406 a decodability index is assigned to the received one or more words based on the analysis of the received one or more words using the plurality of effects. For example, as shown in FIG. 5, the word “airplane” has a decodability index of 4.071, while the simpler word “jet” has a decodability index of 1.055. Looking at the components that result in the 4.071 decodability index of “airplane,” the word has a word frequency effect of 0.452, a discrepancy effect of 2, a conditional vowels effect of 0.27 and 0.349, and a consonant blends effect of 1. “Jet,” on the other hand, has only two components, a word frequency effect of 0.474 and a conditional vowels effect of 0.58, resulting in a decodability index of 1.054. Therefore, the decodability index indicates that “jet” is easier to pronounce or to sound out than “airplane.”

In the above examples, the plurality of effects used to determine the decodability index were added together to arrive at the decodability index. However, it is to be appreciated that other mathematical functions may be performed on the plurality of effects for quantification to arrive at value that reflects. For example, in some instances the values for each of the plurality of effects can be averaged, including taking a weighted average where the value of some of the plurality of effects is weighted more heavily when determining the decodability index than the value of other effects. Other non-limiting examples of quantification of the plurality of effects that comprise the decodability index include standard deviation, mean, median, mode, using ranges (where some values are not considered if they are within a certain range or out of a certain range), absolute values, tallying frequencies of words with certain scores (for example, you would not want a children's book for a beginning reader to have more than 50% of its words with a score of 5 or higher) and representing this as a ratio, discounting the total word score for each repeated word (“bread” gets 5 points the first time, 4 the second time it appears, etc.) and then averaging the words or summing the effects, and the like.

In some instances, the decodability index is determined using one or more additional effects. Below, in Table 1, are non-limiting, non-exhaustive examples of additional effects that may be considered when arriving at a decodability index for one or more words, each of which are fully incorporated by reference (where applicable):

TABLE I
Examples of Additional Effects

| Effect | Measurement/Database Source |
|---|---|
| Phonotactic probability | http://phonotactic.dept.ku.edu/ |
| | (Michael Vitevitch) |
| | https://kuscholarworks.ku.edu/handle/1808/19929 |
| | (Holly Storkel) |
| Orthographic similarity | http://talyarkoni.org/resources |
| | - or - |
| | Marian, V., Bartolotti, J., Chabal, S., & Shook, A. (2012). |
| | CLEARPOND: Cross-linguistic easy-access resource for |
| | phonological and orthographic neighborhood densities. |
| | PloS one, 7(8), e43230. |
| Neighborhood effects | Marian, V., Bartolotti, J., Chabal, S., & Shook, A. (2012). |
| | CLEARPOND: Cross-linguistic easy-access resource for |
| | phonological and orthographic neighborhood densities. |
| | PloS one, 7(8), e43230. |
| Age of Acquisition | Kuperman, V., Stadthagen-Gonzalez, H., & Brysbaert, M. (2012). |
| | Age-of-acquisition ratings for 30,000 English words. |
| | Behavior Research Methods, 44(A), 978-990. |
| Imageability | Cortese, M. J., & Fugett, A. (2004). Imageability ratings for 3,000 |
| | monosyllabic words. Behavior Research Methods, 36(3), 384-387. |
| Concreteness | Brysbaert, M., Warriner, A. B., & Kuperman, V. (2014). |
| | Concreteness ratings for 40 thousand generally known English |
| | word lemmas. Behavior research methods, 46(3), 904-911. |
| Voice-key bias (initial | The largest proportion of unique variance was attributable to |
| phoneme effect) | initial phoneme: voiced initial phonemes triggered the voice key |
| | faster than unvoiced; fricatives activated the voice key later than |
| | other phonemes; and bilabials, labiodentals, and velars gave rise |
| | to faster voice-key responses than did phonemes with alternative |
| | places of articulation. |
| Uniqueness point | Radeau, M., & Morais, J. (1990). The uniqueness point effect in |
| | the shadowing of spoken words. Speech Communication, 9(2), |
| | 155-164. |
| Morphology (ratio of | Schreuder, R., & Baayen, R. H. (1997). How complex simplex |
| noun/verb) | words can be. Journal of memory and language, 37(1), 118-139. |
| Onset/rime effect | Ziegler, J. C., & Goswami, U. (2005). Reading acquisition, |
| | developmental dyslexia, and skilled reading across languages: a |
| | psycholinguistic grain size theory. Psychological bulletin, 131(1), 3. |
| | Goswami, U., & Mead, F. (1992). Onset and rime awareness and |
| | analogies in reading. Reading Research Quarterly, 153-162. |
| Linguistic effects | Perhaps certain linguistic segments (larger than phonemes, |
| | smaller than words) of letters have more predictability |
| | (are more stable). |
| Zipf's law | Zipf's law states that given some corpus of natural language |
| | utterances, the frequency of any word is inversely proportional to |
| | its rank in the frequency table. Thus, the most frequent word will |
| | occur approximately twice as often as the second most frequent |
| | word, three times as often as the third most frequent word, etc.: |
| | the rank-frequency distribution is an inverse relation. |

For example, analyzing the received one or more words using the plurality of effects may comprise analyzing all or a portion of the received one or more words using a word frequency effect, a discrepancy effect, and a conditional score such as a conditional vowels effect and one or more additional effects; or analyzing the received one or more words using the plurality of effects may comprise analyzing all or a portion of the received one or more words using a word frequency effect, a discrepancy effect, a conditional vowels effect, a consonant blends effect and one or more additional effects. The additional effects may comprise one or more of a phonotactic probability effect, an orthographic similarity effect, a neighborhood effect, an age of acquisition effect, an imageability effect, a concreteness effect, a uniqueness point effect, and an onset/rime effect.

In some instances, the one or more words used to determine a decodability index comprise an article, a magazine, a book, etc., and the decodability index is assigned to the entire article, magazine or book. For example, the decodability index can be assigned to the entire article, magazine or book by adding together the decodability index for each word of the article, magazine or book, by taking an average of the decodability index for each word of the article, magazine or book, or by any other means of quantifying the difficulty of pronouncing the words that comprise the article, magazine, book, etc. In some instances, the decodability index can be assigned to the entire article, magazine or book by taking a sample of words that comprise the article, magazine or book and adding together the decodability index for each of the sample of words, wherein the sample of words is less than all of the one or more words that comprise the article, magazine or book. In other instances, the decodability index can be assigned to the entire article, magazine or book by taking a sample of words that comprise the article, magazine or book and taking an average of the decodability index for each of the sample of words, wherein the sample of words is less than all of the one or more words that comprise the article, magazine or book. The size of the sample can be determined using statistical analysis so that a confidence for the assigned decodability index can be provided.

An advantage of determining the decodability index for the article, magazine, book, etc. is the ability to assign a written piece of literature (e.g., article, magazine, book, etc.) to a reader based on the decodability index that has been assigned to the entire article, magazine or book. For example, a person's ability to match graphemes with phonemes can be assessed, and that assessment can be used to recommend literature having a certain decodability index or range of decodability indexes. In some instances, assessing the reader's ability match graphemes with phonemes can be performed using, for example, voice recognition software.

In some instances, the assessment of a person's ability to match graphemes with phonemes is performed using one or more known assessment techniques. For example, a person (e.g., child) obtains an assessment using an existing measure of decoding (e.g., a subtest from the Woodcock Johnson Psychoeducational Battery-IV called Word Attack). The information from this assessment is used to select an appropriate text (e.g., article, magazine, book, etc.) that has the appropriate decodability index assigned to it for this child. In other instances, the decodability index can be used to assess the person's (e.g., child's) ability to match graphemes with phonemes. For example, the child can be administered one or more words and monitored to determine the child's ability to match the graphemes of the one or more words with the correct phonemes. The decodability index can be assigned to the child based on their ability to match graphemes with phonemes of one or more words that have an assigned decodability index. This information can be used to select an appropriate text that has the appropriate decodability level assigned to it (from the disclosed decodability index) for this child.

Consider the following non-limiting method for performing an assessment. The assessment comprises several items such as words or word segments that would each be ‘tagged’ (i.e., assess and assigned, as described herein) with a decodability index. A person (e.g., child) reads these printed pre-evaluated words or word segments out loud and their pronunciation of the word or word segments is recorded. The recorded pronunciation is then evaluated for errors matching graphemes with phonemes and blending them with surrounding phonemes to create/read words. For example, the reading of the printed word, word segment or words can be recorded and analyzed using a processor programmed to compare the recorded sounds to the correct accurate reading of the word or word segments. Errors are identified based on this comparison and patterns of errors that can be associated with a specific decodability index for words or word segments can be identified and assessed. Recommendations for instruction, intervention, or texts can be provided based on the assessment. Alternatively, the pre-evaluated word or word segment can be electronically generated using a processor programmed to audibly output the word or word segment (using correct matching of graphemes with phonemes and blending them with surrounding phonemes to create/read words). For example, a computer or a smart device such as a smart phone can be programed to audibly emit the word or word segment. The subject (e.g., child) then picks which word (out of a plurality (e.g., four) of choices) that the person thinks sounds like that word. This can be done using a display of the computer or smart device. If the person has a pattern of errors that can be associated with a specific decodability index for words or word segments, this is assessed and recommendations for instruction, intervention, texts can be provided based on the assessment.

Also consider this more specific (yet also non-limiting) example of an assessment: (Step 1) A child hears an app executing on a smart device (e.g., smart phone) read the word ‘hope’ and the child is asked by the app to pick (using the display and input mechanisms (keyboard, touch screen, etc.) of the smart device) which of the following is the word s/he just heard: a) hope, b) hop c) hoop d) hooped and/or e) hops. (Step 2) The child picks b) hop, which is incorrect, suggesting the child has a problem with the o_e pattern. (Step 3) The word “hope” has been assessed and assigned a decodability index and based on the assigned decodability index, the app executing on the smart device recognizes the word “hope” has a o_e→/O/ grapheme to phoneme correspondence and that the word “hope” has no blends (based on the decodability index). (Step 4) Based on statistical analysis of the words and word segments and the decodability index assigned to the words and word segments that are presented to the child, a processor associated with the smart device executes software to determine the child's pattern of errors after several words and/or word segments (each having an associated decodability index) are presented to the child and the child responds to the word/word segment s/he heard. (Step 5) A report is generated by the smart device that shows the child's weakest grapheme—phoneme matches, and which blends were hardest, etc. (Step 6) Because there are over 300 grapheme to phoneme matches, the report could suggest ‘high-utility’ correspondences to teach. Here, ‘high-utility’ refers to the correspondences that the child is very likely to encounter in text. Alternatively, the app may use pseudo-words. For example, the app audibly generates the pseudo-word “lope” out loud and the child sees the following choices to choose from: a) loop b) lope or c) lopp. The correct answer would be b because the vowel_e pattern in English creates a long vowel sound. The point of using pseudo-words would be to remove prior exposure effects when testing kids as some kids might have encountered the words before and memorized them, whereas they most likely would not have encountered the pseudo-word “lope” before.

As noted herein, in some instances, it may be desired to obtain feedback from a reader to assess the reader's ability to read one or more words having a given decodability index. For example, a person or a class of people that have difficulty matching certain grapheme-phonemes and/or and blending them with surrounding phonemes to create/read words may have a specific decodability index for one or more words (e.g., articles, magazines, books, etc.) that contain numerous instances of those certain phonemes. In other words, the decodability index for an article, magazine, book, etc. that contains numerous instances of those certain phonemes will indicate a higher level of difficulty for that person or class of persons than it would for the common masses. Though the example illustrates phonemes, this can apply to various effects that comprise the decodability index. In other words, the various effects that are combined to arrive at the decodability index may be weighted to reflect a reader's ability to match certain graphemes and phonemes so that a reading program can be developed specifically for that person or class of persons. This can also be used in assisting a learning reader as a reading program can be tailored to that person or class of persons (such as disability status) based upon that person's or the class's personalized decodability index. It is to be appreciated that the decodability index can be calculated for text in any language. It is not limited to English or any one language.

In addition to having the decoding measure interactively adapt to the learner's level (as in a computer program to teach reading), the decoding measure can also adapt based on a learner's native language. For example, if a student is a native Spanish speaker, and is now learning English, they will be unfamiliar with orthographic units such as final silent e in “hope”, as there are very few if any final silent e's in Spanish. Therefore, this orthographic-phonemic mapping (final silent e) could be given a higher (or lower score depending on the directionality of the scale) score in the conditional (currently 3rd effect) part of the decoding measure. In contrast, a native French speaker is familiar with the notion that the final e can be silent (because it is often silent in French), and therefore a word such as “hope” would not be as difficult to decode. The aforementioned example used a known letter that exists in all three languages (“e”), but it can also be applied to unknown phonemes/letters. For example, learning a completely new letter that is paired with a completely new sound might be even more difficult. Generally, this language adaptability occurs through weighting within the conditional part of the decodability index and not altering the frequency, discrepancy, or blends effects subtotals. However, in altering the subtotal of the conditional part, it would change the overall decoding measure score of words with silent e for that individual (or for all native Spanish-speaking individuals.) It is to be appreciated that the concept of a person who is native in one language and learning another language (e.g., English) as a second language is separate from the concept that the decodability index can be calculated for text in any languages (an emerging English reader learning English or a Spanish-speaking illiterate adult learning Spanish for the first time).

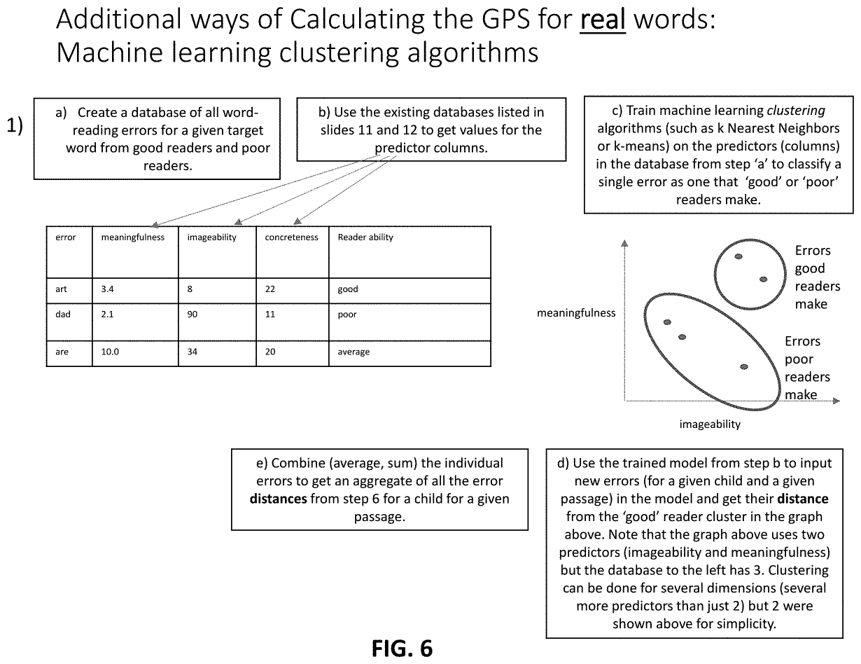

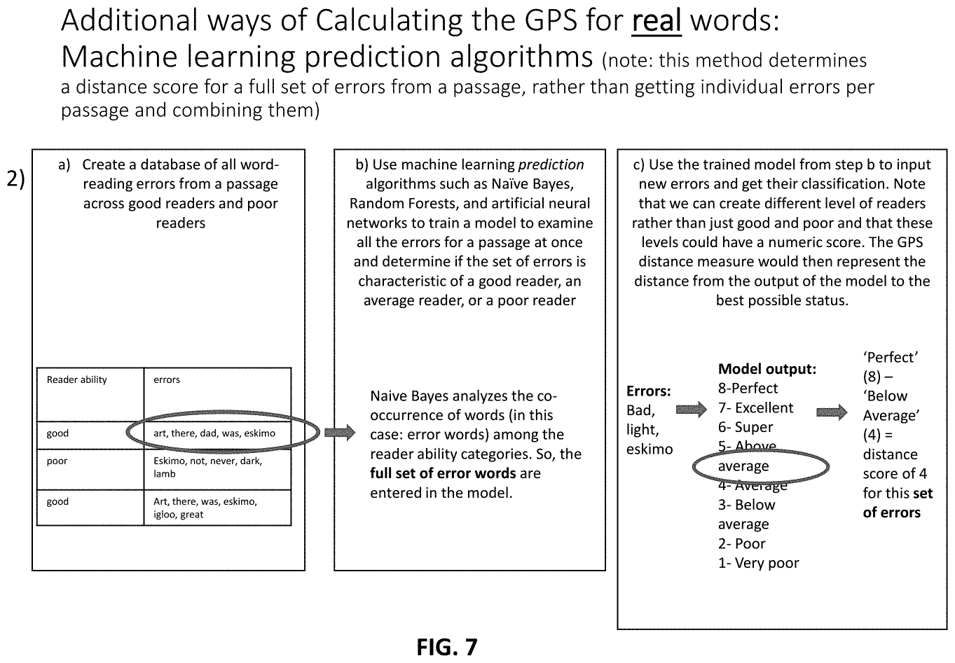

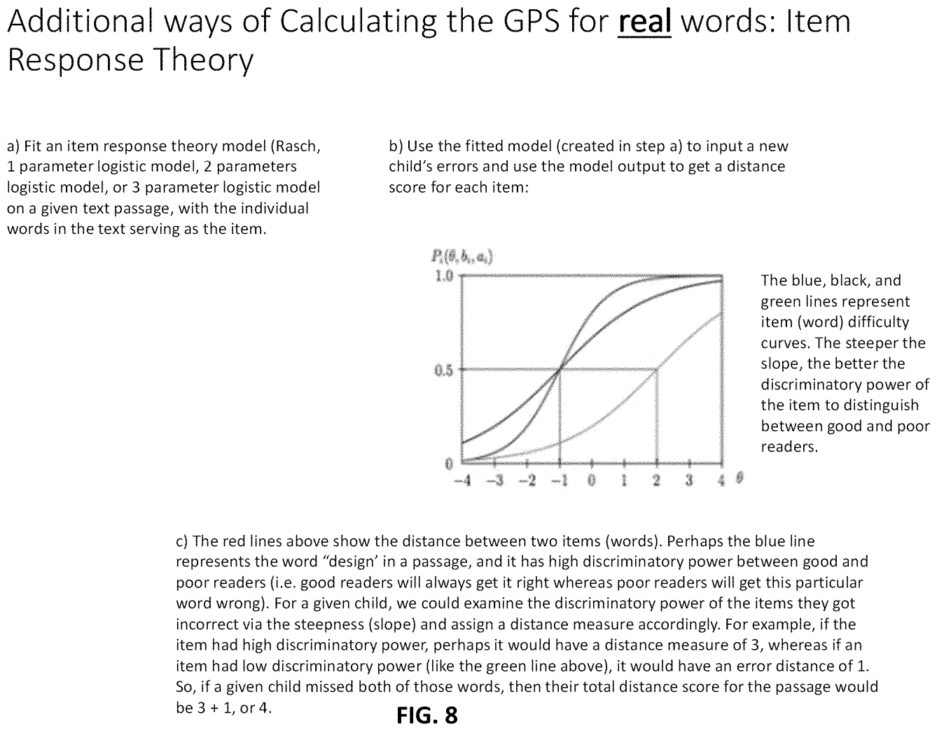

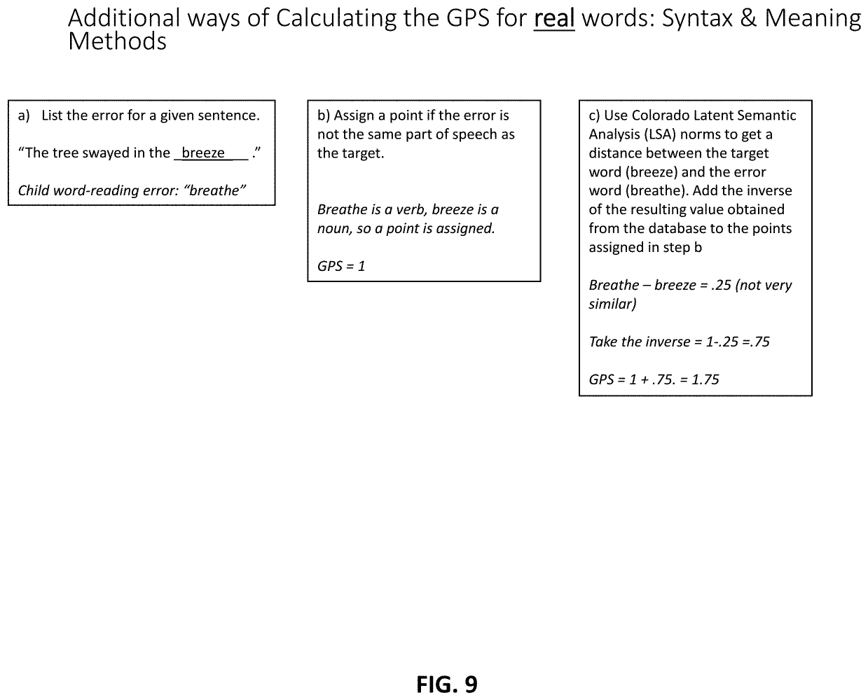

As noted above, alternatively or optionally to calculating a decodability index, various other metrics can be used for calculating a score by the computing device for the target word (step 206), calculating a score by the computing device for the error word (step 208), and/or calculating a GPS metric for word-error pairs (steps 206-212 of FIG. 2A) when the error word is a real word. For example, FIG. 6 illustrates and describes a method of calculating the GPS metric for a word-error pair when the error word is a real word using machine-learning clustering algorithms performed by the computing device. In another example of calculating a score by the computing device for the target word (step 206), calculating a score by the computing device for the error word (step 208), and/or calculating a GPS metric for word-error pairs (steps 206-212 of FIG. 2A) when the error word is a real word, FIG. 7 illustrates and describes a method of calculating the GPS metric for a word-error pair when the error word is a real word using machine-learning prediction algorithms. FIG. 8 illustrates yet another exemplary method of calculating the GPS metric for a word-error pair when the error word is a real word using item response theory. And, as a final but not-exhaustive and non-limiting example of a method of calculating the GPS metric for a word-error pair when the error word is a real word, FIG. 9 illustrates and describes calculating the GPS metric for a word-error pair when the error word is a real word using syntax and meaning methods.

Returning to FIG. 2A, if, at 204, the error word is a made-up word, then a distance score is calculated for the target-error word pair when the error word is a made-up word. This may also be performed by various processes and/or methods. As one non-limiting example, as shown in FIG. 2A, at 214 a GPS score is calculated by the computing device for the target word and the error word. In this example, the difference in the number of sounds between the target word and the error word is determined, quantified and calculated by the computing device. At 216, an absolute value is determined for the value calculated at 214.

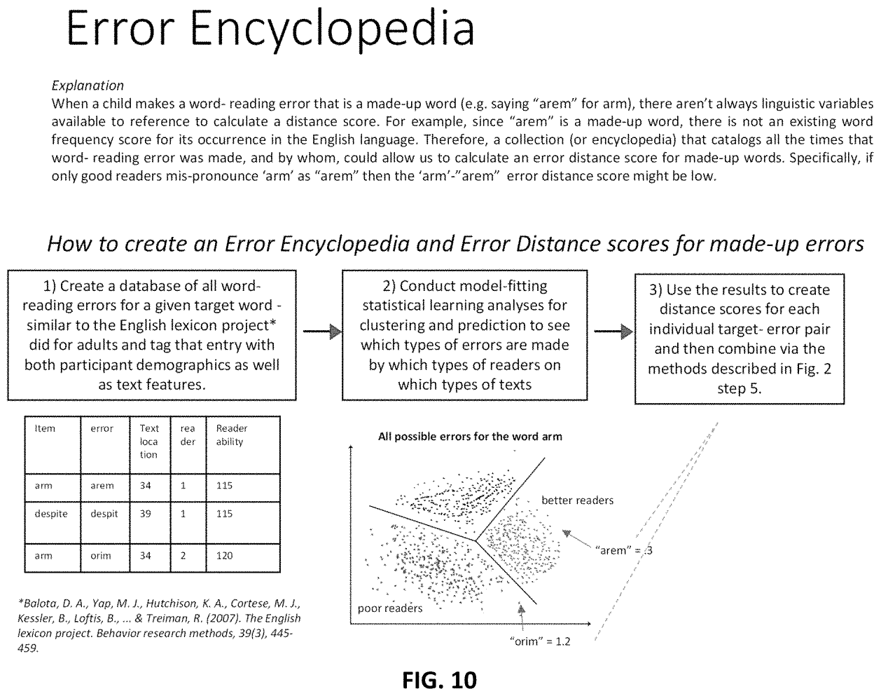

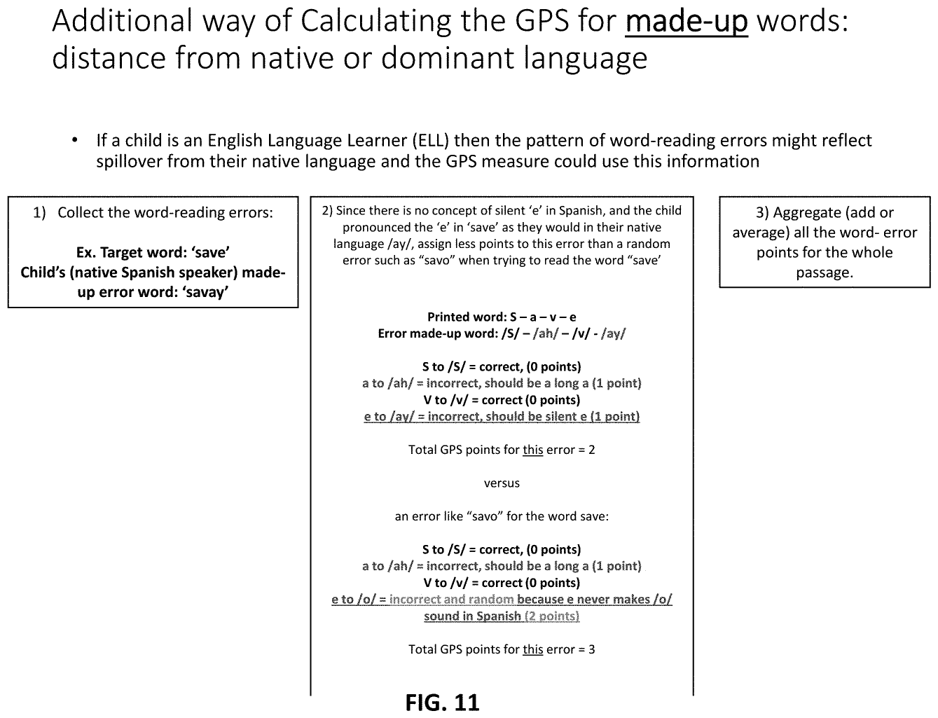

Similar to calculating the GPS metric when the error word is a real word, there are various other ways to calculate the GPS matric for word-error pairs when the error word is a made-up word, other than the method shown in FIG. 2A. For example, FIG. 10 illustrates and describes an exemplary method of calculating the GPS metric for a word-error pair when the error word is a made-up word using an error encyclopedia. FIG. 11 illustrates and describes an exemplary method of calculating the GPS metric for a word-error pair when the error word is a made-up word by determining a distance of the error word from a native or dominant language word. These are non-exhaustive and non-limiting examples of methods of calculating the GPS metric for a word-error pair when the error word is a made-up word using an error encyclopedia.

Regardless of the methods used to calculate the GPS metric for word-error pairs when the error word is a real word and the methods used to calculate the GPS metric for word-error pairs when the error word is a made-up word, at step 218 (FIG. 2A), an average (or other statistical evaluation, e.g., standard deviation, median, mode, sum, ranges, etc.) is calculated by the computing device for the GPS metrics for all the word-error pairs (real word and made-up word error words) to obtain a global GPS metric for the text passage for the first person. At 220, this global GPS metric is used to create a report (see FIGS. 3A and 3B).

FIGS. 2B and 2C illustrate alternative methods of calculating a score (i.e., a GPS panel) for word-error pairs. Referring to FIG. 2B, at 222, word-error pairs are entered into the computing system for scoring, as described herein. A word-error pair is comprised of a target word (the word that is in the text passage), and an error word (the word that was said out loud by the first person when reading the target word). For example, the target word may be “drag” and the error word may be “dog,” At 224, the number of phonemes in each, the target word and the error word are calculated and the absolute value of the target word phonemes minus the error word phonemes is calculated. This is done for all the target-error word pairs and summed or averaged for a passage. At 226, the number of correct phonemes in the error word (i.e., the number of error phonemes that are present in the target) is determined. This is done for all the target-error word pairs and summed or averaged for a passage. At 228, it is determined whether the first, second, and final phonemes in the target word and the error word were correct. Do this for all the target-error word pairs and sum or average for a passage. At 230, the total number of phonemes correct and in the correct order (note that this includes more than just the first, second, and last match and is different than the above calculation) is determined. This is done for all the target-error word pairs and summed or averaged for a passage. At 232, different statistical and/or algebraic/numerical operations are performed on the results of steps 224-230 to determine the GPS panel. For example, a ‘gross’ measure of decoding ability could be determined by looking at the results of step 224. Whereas, a more nuanced method could see if the child is trying to apply letter-sound knowledge sequentially, and the results of 228 or 230 would be more appropriate. The various methods in 224-230 can answer the following questions: 1) Are they completely guessing? (If so, the value of step 224 would be very high); Are they using letter-sound knowledge to decode the word? (If so, the value of 226 should be high); Are they carefully looking at all the letter-sounds in the word and attempting to apply letter-sound knowledge sequentially? (If so, the value of step 230 should be high). At step 234, results are presented and displayed in a GPS report (see FIGS. 3A and 3B).

FIG. 2C illustrates yet another flowchart illustrating an embodiment of a method of calculating a score (i.e., a GPS panel) for word-error pairs. At 242, word-error pairs are entered into the computing system for scoring, as described herein. A word-error pair is comprised of a target word (the word that is in the text passage), and an error word (the word that was said out loud by the first person when reading the target word). At step 244, the sequence of the child's phonics instruction from their curricula is determined. At 246, the child's performance on target words that include phonics that have been covered in the child's curricula (step 244) is determined. At step 248, results are presented and displayed in a GPS report (see FIG. 3 as an example).

It is to be appreciated that the above described steps can be performed by computer-readable instructions executed by a processor. As used herein, a processor is a physical, tangible device used to execute computer-readable instructions. The steps performed by the processor include not only determining a score and a GPS metric for a word or group of words, but also for the assessment of a reader, providing a personalized GPS metric for a person or class of persons, and for providing recommendations to a teacher based upon an assigned GPS metric (personalized or otherwise). For example, the GPS metric can be used in a method of evaluating reading instruction. The method may comprise 1202 establishing a baseline GPS metric for a first person (e.g., student, child, etc.). In some instances, establishing the baseline may comprise, prior to providing the reading instruction to the first person regarding matching certain graphemes of printed text with their correct phonemes and blending them with surrounding phonemes to create/read words, the first person reads out loud a text passage that has one or more words or word segments that contain one or more certain graphemes; one or more pre-instruction word error pairs are recorded, generated and extracted as the first person reads the text passage out loud, wherein each pre-instruction word error pair is comprised of the target word from the text passage that includes the one or more certain graphemes and the error word as the target word is read by the first person while reading the text passage out loud; scoring, by the computing system, each of the generated and extracted pre-instruction word error pairs and generating a pre-instruction GPS metric for the text passage as read by the first person, wherein the pre-instruction GPS metric is a quantified pre-instruction measurement of a difference between sub-lexical aspects of the target word and sub-lexical aspects of the error word; and, generating and displaying, by the computing system, the pre-instruction GPS metric for the text passage as read by the first person, wherein the pre-instruction GPS metric indicates a position of the first person on a spectrum of word recognition prior to receiving the reading instruction.

At 1204, reading instruction is provided to the first person regarding matching certain graphemes of printed text with their correct phonemes and/or blending them with surrounding phonemes to create/read words. At 1206, a text passage is provided to the first person that has one or more words or word segments that contain one or more of the certain graphemes. At 1208, one or more word pairs are recorded, generated and extracted as the first person reads the text passage out loud, wherein each word error pair is comprised of a target word from the text passage that includes the one or more certain graphemes and an error word as the target word is read by the first person while reading the text passage out loud. At 1210, the word pairs are scored, by a computing system, and a post-instruction GPS metric is generated for the text passage as read by the first person, wherein the post-instruction GPS metric is a quantified measurement of a difference between sub-lexical aspects of the target word and sub-lexical aspects of the error word. At 1212, the post-instruction GPS metric for the text passage as read by the first person is displayed by the computing system, wherein the post-instruction GPS metric indicates a position of the first person on a spectrum of word recognition. And, at 1214, the pre-instruction GPS metric is compared to the post-instruction GPS metric to evaluate the reading instruction.

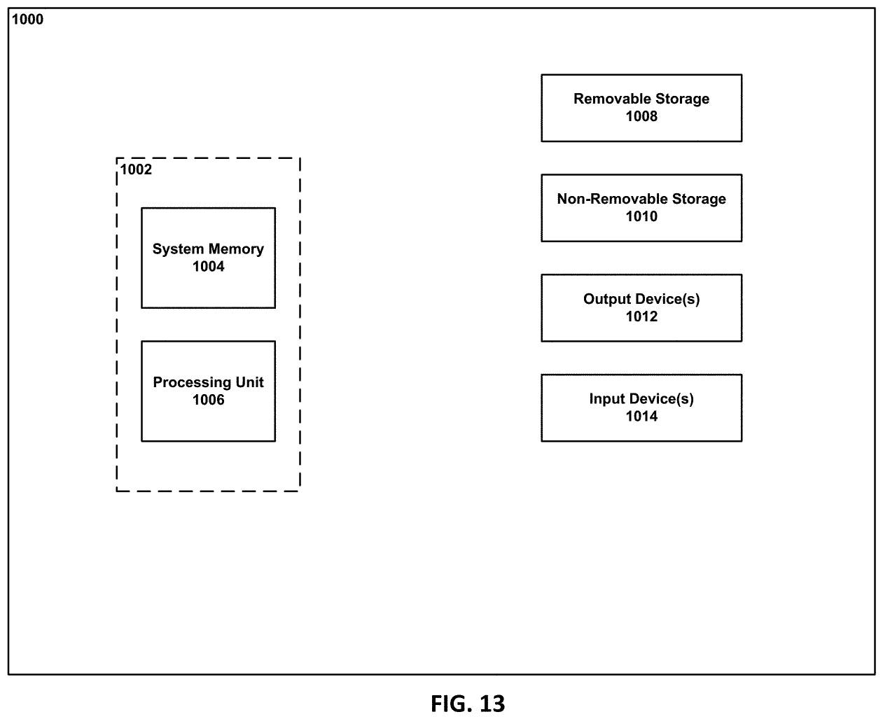

When the logical operations described herein are implemented in software, the process may execute on any type of computing architecture or platform. For example, referring to FIG. 13, an example computing device upon which embodiments of the invention may be implemented is illustrated. In particular, at least one processing device described above may be a computing device, such as computing device 1000 shown in FIG. 13. For example, computing device 1000 may be a component of the cloud computing and storage system. Computing device 1000 may comprise all or a portion of server. The computing device 1000 may include a bus or other communication mechanism for communicating information among various components of the computing device 1000. In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 13 by dashed line 1002. The processing unit 1006 may be a standard programmable processor that performs arithmetic and logic operations necessary for operation of the computing device 1000.

Computing device 1000 may have additional features/functionality. For example, computing device 1000 may include additional storage such as removable storage 1008 and non-removable storage 1010 including, but not limited to, magnetic or optical disks or tapes. Computing device 1000 may also contain network connection(s) 1016 that allow the device to communicate with other devices. Computing device 1000 may also have input device(s) 1014 such as a keyboard, mouse, touch screen, scanner, etc. Output device(s) 1012 such as a display, speakers, printer, etc. may also be included. The additional devices may be connected to the bus in order to facilitate communication of data among the components of the computing device 1000. All these devices are well known in the art and need not be discussed at length here. Though not shown in FIG. 13, in some instances computing device 1000 includes an interface. The interface may include one or more components configured to transmit and receive data via a communication network, such as the Internet, Ethernet, a local area network, a wide-area network, a workstation peer-to-peer network, a direct link network, a wireless network, or any other suitable communication platform. For example, interface may include one or more modulators, demodulators, multiplexers, demultiplexers, network communication devices, wireless devices, antennas, modems, and any other type of device configured to enable data communication via a communication network. Interface may also allow the computing device to connect with and communicate with an input or an output peripheral device such as a scanner, printer, and the like.

The processing unit 1006 may be configured to execute program code encoded in tangible, computer-readable media. Computer-readable media refers to any media that is capable of providing data that causes the computing device 1000 (i.e., a machine) to operate in a particular fashion. Various computer-readable media may be utilized to provide instructions to the processing unit 1006 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

Computing device 1000 typically includes a variety of computer-readable media. Computer-readable media can be any available media that can be accessed by device 1000 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Below are provided non-limiting and non-exhaustive example uses of the GPS metric. The GPS index can be used in several different ways. For example, it can be used to determine a more nuanced/sensitive indicator of reading level/ability than a standardized test such as the Woodcock-Johnson Word Attack sub-test or words correct per minute. Regarding the standardized test, these forms cannot be administered several times within a short period of time because it violates the testing procedures. Therefore, having a child read out loud and examining the errors via the GPS index might provide an easier, faster, lower-cost alternative to determining reading ability than standardized testing. Currently, children read R-CBMs out loud and their words correct per minute (WCPM) is used as a simple indicator of their reading ability. However, WCPM does not take into account the sub-lexical errors, rather, a word is simply marked correct or incorrect. This binary classification is not as nuanced and sensitive to change as a numeric score. Therefore, the GPS index is able to provide a simple (like WCPM), but more nuanced, indicator of reading ability.

In addition to informing a particular child's current reading ability (and their growth over time) the GPS index can be used to examine a particular child's response to a specific reading curricula. For example, if a student is struggling with learning silent ‘e’, and a teacher provides more intensive instruction using a reading program that focuses on silent ‘e’, the GPS index (and not standardized testing, or WCPM) shows if the child is making growth/progress on silent ‘e’ words. If the GPS index does indeed show the child is making progress, but struggles with digraphs, then an instructional modification focusing on digraphs can be instituted. In this way, the GPS index can be used to make individualized instructional changes. This latter idea is sometimes referred to as Data-based Individualization (DBI) in the educational field, however, teachers have been instructed to analyze and theorize about the student's errors rather than use a systematic approach. In some instances, the GPS index is more sensitive to change than the way current R-CBMs are scored. This could be particularly useful for populations of students with or at-risk for reading disability or language impairments.

Yet another use of the GPS index is to match a student to text that is at the appropriate level (not too hard, not too easy). For example, if a student is struggling with digraphs (as evidenced by the GPS index report) then text that avoids digraphs could be selected by the teacher. Or, if the teacher wanted to practice with the student, texts that contain digraphs could be provided.

Further, the GPS index can be used to assess reading ability using texts or books found in the child's environment. This is arguable a more naturalistic type of assessment than standardized assessments or R-CBMs.

Another application of the GPS index is as a teaching tool. Right now, teachers listen to children read books and then decide what they should teach next based on their performance. The GPS index can automate this process and provide reliable instructional suggestions.

And yet another application is as a special education screening tool. If certain error mappings are identified that only certain populations of students make (e.g., students with dyslexia), then screening for these errors could flag students who need to have further reading disability testing.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method of determining grapho-phonetic strategy (GPS) for a text passage read by a first person comprising:
generating and extracting one or more word error pairs as a first person reads a text passage out loud, wherein each word error pair is comprised of a target word from the text passage and an error word as the target word is read incorrectly by the first person while reading the text passage out loud;
scoring, by a computing system, each of the generated and extracted word error pairs and generating a GPS metric for the text passage as read by the first person, wherein the GPS metric is a quantified measurement of a difference between sub-lexical aspects of the target word and sub-lexical aspects of the error word; and
generating and displaying, by the computing system, the GPS metric for the text passage as read by the first person, wherein the GPS metric indicates a position of the first person on a spectrum of word recognition.

2. The method of claim 1, wherein the spectrum of word recognition is from guessing to effortless, errorless reading.

3. The method of claim 1, wherein generating and extracting one or more word error pairs comprises recording the word error pairs as the words are read from the text passage by the first person.

4. The method of claim 1, wherein the text passage is all or part of a R-CBM (reading curriculum based measurement).

5. The method of claim 3, wherein recording the word error pairs comprises the a second person marking the first person's word error pairs as the first person reads the text passage.

6. The method of claim 1, wherein the word error pairs are entered into the computing system.

7. The method of claim 6, wherein the word error pairs are entered into the computing device using a peripheral device such as, for example, a scanner that using optical character recognition that identifies, extracts, and digitizes the word-error pairs for the given text passage.

8. The method of claim 1, wherein alternatively, the first person reads the text passage out loud into a microphone and the word error pairs are recorded by the computing system using speech recognition software.

9. The method of claim 1, wherein scoring, by a computing system, each of the generated and extracted word error pairs and generating a GPS metric for the text passage as read by the first person comprises calculating a score for each word error pair by:
calculating a target word score for a first target word using a scoring index;
calculating an error word score for a first error word that corresponds to the first target word using the scoring index;
subtracting the error word score from the target word score and taking an absolute value of the result to determine a distance measure between the target word and the error word;
repeating the above two steps for each of the word error pairs recorded as the text passage was read by the first person; and
generating the GPS metric for the text passage as read by the first person by performing a statistical operation on all of the distance measures between the target words and each target word's corresponding error word to obtain a global GPS metric for the text passage for the first person.

10. The method of claim 9, further comprising determining whether the error word of each word error pair is a real word or a made-up word and using a different scoring index if the error word is a made-up word than if the error word is a real word.

11. The method of claim 9, wherein the statistical operation on all of the distance measures comprises taking an average of all of the distance measures between the target words and each target word's corresponding error word or taking a standard deviation of all of the distance measures between the target words and each target word's corresponding error word.

12. The method of claim 10, wherein the scoring index used when the error word is a real word includes using one or more of a decodability index, a machine-learning clustering algorithm, a machine-learning prediction algorithm, item response theory, and/or syntax and meaning methods.

13. The method of claim 10, wherein the scoring index used when the error word is a made-up word comprises assigning a quantitative value to a number of sounds in the target word and a number of sounds in the target word's corresponding error word and calculating a difference in the number of sounds between the target word and the error word, using an error encyclopedia, and/or determining a distance of the error word from a native or dominant language word.

14. A method of evaluating reading instruction using a grapho-phonetic strategy (GPS) metric, said method comprising:
providing reading instruction to a first person regarding matching certain graphemes of printed text with their correct phonemes and/or and blending them with surrounding phonemes to create/read words;
providing a text passage that has one or more words or word segments that contain one or more of the certain graphemes;
recording generating and extracting one or more word error pairs as the first person reads a text passage out loud, wherein each word error pair is comprised of a target word from the text passage that includes the one or more certain graphemes and an error word as the target word is read by the first person while reading the text passage out loud;
scoring, by a computing system, each of the generated and extracted word error pairs and generating a post-instruction GPS metric for the text passage as read by the first person, wherein the post-instruction GPS metric is a quantified measurement of a difference between sub-lexical aspects of the target word and sub-lexical aspects of the error word; and
generating and displaying, by the computing system, the post-instruction GPS metric for the text passage as read by the first person, wherein the GPS metric indicates a position of the first person on a spectrum of word recognition.

15. The method of claim 14, wherein the spectrum of word recognition is from guessing to effortless, errorless reading.

16. The method of claim 14, wherein prior to providing the reading instruction to the first person regarding matching certain graphemes of printed text with their correct phonemes and/or blending them with surrounding phonemes to create/read words:
the first person reads out loud the text passage that has the one or more words or word segments that contain the one or more of the certain graphemes;
one or more pre-instruction word error pairs are recorded, generated and extracted as the first person reads the text passage out loud, wherein each pre-instruction word error pair is comprised of the target word from the text passage that includes the one or more certain graphemes and the error word as the target word is read by the first person while reading the text passage out loud;
scoring, by the computing system, each of the generated and extracted pre-instruction word error pairs and generating a pre-instruction GPS metric for the text passage as read by the first person, wherein the pre-instruction GPS metric is a quantified pre-instruction measurement of a difference between sub-lexical aspects of the target word and sub-lexical aspects of the error word;
generating and displaying, by the computing system, the pre-instruction GPS metric for the text passage as read by the first person, wherein the pre-instruction GPS metric indicates a position of the first person on a spectrum of word recognition prior to receiving the reading instruction; and
comparing the pre-instruction GPS metric to the post-instruction GPS metric to evaluate the reading instruction.

17. The method of claim 16, wherein the reading instruction is changed based on the comparison of the pre-instruction GPS metric to the post-instruction GPS metric.

18. A method of determining a grapho-phonetic strategy (GPS) metric for a first person, said method comprising:
generating, by a processor, a word, wherein the word is audibly and/or visually displayed to the first person;
receiving, by the processor, an input from a first person to select the at least one word from a plurality of displayed or audibly generated words, wherein only one of the plurality of displayed or audibly generated words is correct;
perform, by the processor, a statistical analysis of the word and an index assigned to the word that is presented to the first person, wherein the processor determines a pattern of errors for the first person after several words and/or word segments, each having an associated index, are presented either audibly or visually to the person and the corresponding input form the first person;
generating, by the processor, the GPS metric for the first person that shows an ability of the first person to match graphemes in the words and/or word segments with their correct phonemes.

19. The method of claim 18, wherein the GPS metric indicates a position of the first person on a spectrum of word recognition.

20. The method of claim 19, wherein the spectrum of word recognition is from guessing to effortless, errorless reading.
